(19) United States
(12) Patent Application Publication
(10) Pub. No.: US 2004/0258825 A1
(43) Pub. Date: Dec. 23, 2004

(54) Nutritional compositions containing spray dried fiber

(76) Inventors: Louis I. Ndife, Columbus, OH (US); Booker T. Lucas III, Columbus, OH (US); Karin M. Ostrom, Marlborough, CT (US)

Correspondence Address: ROSS PRODUCTS DIVISION OF ABBOTT LABORATORIES, DEPARTMENT 108140-DS/1, 625 CLEVELAND AVENUE, COLUMBUS, OH, 43215-1724, US

(21) Appl. No.: 10/463,242

(22) Filed: Jun. 17, 2003

(51) Int. Cl. C12C 1/00

(52) U.S. Cl. 426/590

(57) ABSTRACT

Disclosed are fiber-containing nutritional powders comprising nutrients and a total dietary fiber component, wherein the total dietary fiber contains added, spray dried, fiber, and wherein at least about 50% by weight of the spray dried fiber is water insoluble. Also disclosed are improved methods of making nutritional powders by (A) preparing an aqueous liquid containing nutrients and added fiber, wherein at least about 50% by weight of the added fiber is water insoluble; (B) homogenizing the prepared aqueous liquid at a selected homogenization pressure; and (C) spray drying the homogenized liquid to form a nutritional powder, which can be formulated or reconstituted into a nutritional liquid. The nutritional formula is more effective than conventional fiber-containing, ready-to-feed, nutritional liquids in treating infants affected by colic, diarrhea, or excessive spit-up.

### TECHNICAL FIELD

The present invention relates to nutritional compositions in powder or liquid form which contain spray-dried fiber, and to methods of using and making the nutritional compositions, especially to methods of treating infants with colic, diarrhea, excessive spit-up, or combinations thereof.

### BACKGROUND OF THE INVENTION

There are many different infant nutritional formulas that are commercially available or otherwise known in the infant formula art. These formulas are prepared as ready-to-feed liquids, concentrated liquids for dilution prior to use, or powders for reconstitution prior to use. Examples of commercially available infant formulas include a variety of products such as Isomil®, Similac®, and Alimentum®, all of which are available from Ross Products Division of Abbott Laboratories, Columbus, Ohio, U.S.A.

Among the many commercially available infant formulas, however, most contain little if any dietary fiber. It is well known that some dietary fiber when added to an infants diet can help eliminate or avoid colic, minimize excessive spit-up, and reduce the severity of some forms of diarrhea. To provide such benefits, a suitable dietary fiber can be added to an infant's diet as a fiber supplement or in the form of an infant formula containing a suitable fiber in an appropriate amount. One such product, which is also commercially available for the dietary management of infants with diarrhea, is Isomil® DF Soy Formula for Diarrhea. This particular product contains soy fiber and is highly effective in the dietary management of some infants with diarrhea, e.g., shortening the duration of loose, watery stools associated with diarrhea. These fiber-containing formulas, however, are only available at this time as ready-to-feed liquids.

The infant formula literature likewise fails to disclose a stable or commercially viable infant formula in powder form, which also contains significant amounts of a dietary fiber such as soy fiber. For example, U.S. Pat. No. 5,021,245 (Borschel et al.) describes infant formulas containing from about 3.1 g to about 14.1 g of soy fiber per liter of formula, but fails to provide any examples of a corresponding powder formulation. The Borschel et al. formulations are highly effective in managing infants with colic, and would be even more useful if it could just as easily be formulated as a reconstitutable powder.

Many consumers prefer nutritional powders as a cost effective alternative to ready-to-feed nutritional liquids. These powders are less costly to ship and store than the corresponding liquids and typically cost less than ready-to-feed liquids. Moreover, a package of powder when opened will generally remain stable for up to about a month, whereas ready-to-feed liquids are not normally recommended for use beyond 24-48 hours after opening.

It has been found that nutritional powders with added fiber can be difficult to formulate and manufacture. When fiber is added to an intermediate composition during the manufacturing process, and subjected to conventional formula processing methods, the formula tends to separate into layers, thus making particle formation via spray drying or other means nearly impossible. It has also been found that added fiber, even when dry mixed into an infant nutritional powder, results in a layered, separated product when reconstituted that is unacceptable for use in infants, and cannot be used in conventional feeding bottles with attached nipples.

It would therefore be desirable to formulate a nutritional powder containing added fiber, and further to produce such a product that can be reconstituted to form an acceptable nutritional suspension for feeding infants or other individuals. It would also be desirable to provide a method of preparing such a product, and further to provide a method of treating colic, diarrhea, and/or excessive spit up, in infants by using a fiber-containing nutritional product derived from a reconstitutable powder.

### SUMMARY OF THE INVENTION

The present invention is directed to a fiber-containing nutritional composition, in either powder or liquid form, comprising (A) protein, fat, carbohydrate, or combinations thereof, and (A) a total dietary fiber component containing added, spray-dried, fiber, wherein at least about 50% of the added, spray-dried fiber is water insoluble.

The present invention is also directed to an improved method of making a nutritional powder, said method comprising (A) preparing an aqueous liquid containing (i) protein, fat, carbohydrate, or combinations thereof, and (ii) from about 0.1 g to about 7 g of added fiber per liter of the aqueous liquid, wherein at least about 50% by weight of the added fiber is water insoluble; (B) homogenizing the prepared aqueous liquid at a homogenization pressure of from about 500 psi to about 1300 psi; and (C) spray drying the homogenized liquid to form a nutritional powder. The nutritional powder can be further processed or reconstituted to form a nutritional liquid.

The present invention is also directed to a method of treating an infant with colic, diarrhea, spit-up, or combinations thereof, said method comprising feeding the infants the nutritional composition of the present invention. The present invention is also directed to a method of providing nutrition and dietary fiber to an infant, said method comprising feeding the infant a nutritional composition of the present invention.

It has been found that the fiber-containing nutritional compositions of the present invention are more effective than conventional fiber-containing, ready-to-feed, nutritional liquids in treating infants affected by colic, diarrhea, or excessive spit-up. In accordance with the compositions and methods of the present invention, these infants can now be treated with lower concentrations and amounts of added dietary fiber, and still achieve similar results, as compared to conventional fiber-containing ready-to-feed liquid formulas that contain higher concentrations or amounts of added dietary fiber, provided that the added dietary fiber component of the compositions of the present invention are spray-dried as described herein, and provided that at least about 50% of the added spray-dried fiber is water soluble as also defined herein.

It has also been found that the manufacturing method of the present invention provides a method of making a fiber-containing nutritional powder, wherein the process formula can be effectively spray dried to form the various nutritional formulas of the present invention. Fiber-containing nutritional powders have heretofore been difficult to formulate due to the presence of the fiber.

### DETAILED DESCRIPTION OF THE INVENTION

The nutritional compositions and methods of the present invention are directed to nutritional compositions containing a nutrient component and a total dietary fiber component. These and other essential or optional characteristics of the nutritional compositions and methods of the present invention are described in detail hereinafter.

The term “infant” as used herein, generally refers to children less than about 1 year of age, and premature or pre-term infants less than about 1 year corrected age.

The term “lipid” as used herein, unless otherwise specified, means fats, oils, and combinations thereof.

The term “carbohydrate” as used herein, unless otherwise specified, means carbohydrates other than fiber.

The term “total dietary fiber” as used herein, unless otherwise specified, means the combination of inherent fiber (i.e., inherent in the added protein) and added fiber in the nutritional compositions of the present invention.

The term “added fiber” as used herein, unless otherwise specified, refers to the fiber component that is formulated into the nutritional compositions of the present invention, which is not inherent in any added protein or other nutrient. Added fiber content can therefore be calculated as total dietary fiber less any inherent fiber.

The term “added, spray-dried, fiber” as used herein refers to “added fiber” which has been spray dried as part of a nutrient base, wherein the nutrient base represents part or all of the final powder infant formula. In this context, the nutrient base therefore comprises added fiber in combination with fat, protein, non-fiber carbohydrates, or combinations thereof. All or substantially all of the ingredients in the nutritional powders are preferably spray dried together, thus avoiding or minimizing the use of any dry mixing steps subsequent to the spray drying step.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The nutritional compositions and methods of the present invention can comprise, consist of, or consist essentially of the essential elements and limitations of the invention described herein, as well as any additional or optional ingredients, components, or limitations described herein or otherwise useful in nutritional formula applications.

### I. TOTAL DIETARY FIBER

The nutritional compositions of the present invention comprise a total dietary fiber component, wherein the total dietary fiber component comprises added, spray-dried, fiber alone or in combination with inherent fiber. The inherent fiber, when present, is typically provided by added protein or similar other materials.

The nutritional powder embodiments of the present invention comprise added, spray-dried, fiber at concentrations ranging of from about 0.1 g to about 5 g, preferably from about 1 g to about 4.5 g, of added fiber per 100 g of nutritional powder. Total dietary fiber levels in the nutritional powder embodiments will therefore typically range from about 1 g to about 7 g, preferably from about 1 g to about 6 g, more preferably from about 2 g to about 6 g, per 100 g of the nutritional powder.

The nutritional liquid embodiments of the present invention also comprise added, spray-dried, fiber, but at concentrations ranging from about 0.1 g to about 7 g, preferably from about 1 g to about 6 g, per liter of the nutritional liquid. Total dietary fiber levels in the nutritional liquid embodiments will therefore typically range from about 1 g to about 9 g, more typically from about 2 g to about 7 g, most typically from about 3 g to about 6 g, per liter of the nutritional liquid.

It has been found that added, spray-dried, fiber concentrations higher than the above described-ranges in both the powder and liquid embodiments of the present invention, especially when the composition comprises soy fiber, can result in a physically unstable product. This formulation instability can result in product separation during and after processing, as well as clogging of formula bottle nipples during administration.

As suggested above, the added fiber component of the compositions of the present invention is a spray-dried dietary fiber, wherein the spray-dried fiber is made up of at least about 50% insoluble fiber, preferably from about 50% to about 90% insoluble fiber and from about 50% to about 10% soluble fiber, more preferably about 80% insoluble fiber and about 20% soluble fiber. As used herein, fiber solubility is defined by and determined in accordance with the American Association of Cereal Chemists (AACC) Method 32-07, which method is described in U.S. Pat. No. 5,085,883 (Garleb et al.), which description is hereby incorporated herein by reference.

The added fiber component of the compositions of the present invention represents up to 100%, preferably from about 10% to 100%, even more preferably from about 50% to 100%, of the total dietary fiber. The total dietary fiber, therefore, may and typically will comprise some inherent fiber provided by added nutrients such as added protein, wherein the inherent fiber represents from zero to about 90%, more typically from 10% to about 50%, by weight of the total dietary fiber. Inherent fiber content typically ranges up to about 3 g, more typically from about 1 g to about 2 g, per 100 g of those nutritional powder embodiments of the present invention that contain an added nutrient component such as protein. Likewise, inherent fiber content in the liquid embodiments will often range up to about 3 g per liter, more typically from about 1 g to about 2 g per liter.

The added fiber for use in the compositions and methods of the present invention may be obtained from any fiber source that is known or otherwise suitable for use in nutritional products, especially those fiber sources suitable for use in liquid and powder infant formulas as described hereinbefore. The fiber source can be a single source, or a combination of sources, provided that the resulting fiber system satisfies the above-described fiber solubility requirements described hereinbefore. Non-limiting examples of suitable added fiber sources for use herein include oat hull fiber, pea hull fiber, soy fiber, beet fiber, cellulose, corn bran, and combinations thereof. Other non-limiting examples of suitable fiber sources include gum arabic, sodium carboxymethylcellulose, guar gum, citrus pectin, low and high methoxy pectin, barley glucans, psyllium, and combinations thereof. Soy fiber is most preferred, especially when used alone and formulated so as to contain about 80% insoluble soy fiber in combination with about 20% soluble soy fiber.

The spray-dried fiber component of the compositions and methods of the present invention is typically in the form of added rather than inherent fiber. Although the compositions of the present invention may and most typically will contain some inherent fiber, the inherent fiber is normally provided with added protein as part of the nutrient component. The inherent fiber may or may not also be spray-dried into the composition, depending upon whether the associated protein is or is not spray dried into the composition.

Total dietary fiber content can readily be determined by the one of ordinary skill in the analytical arts, and for purposes of the present invention is preferably determined in accordance with the AOAC method as set forth and described in Prosky, L.; Asp, N. G.; Schweizer, T. F.; DeVries, J. W.; and Furda, I; “Determinatin of Insoluble, Soluble, and Total Dietary Fiber in Foods and Foods Products: Interlaboratory Study”, J. Assoc. Off. Anal. Chem., 1988, which descriptions are incorporated by reference herein.

### II. NUTRIENTS

The nutritional compositions of the present invention comprise sufficient types and amounts of nutrients to help meet the nutrition needs of the infant or other intended user. These formulas preferably comprise lipids, proteins, carbohydrates, or combinations thereof, and more preferably further comprise vitamins, minerals, or combinations thereof. All of these nutrients are preferably spray dried together as a nutrient base in combination with the added fiber component as described hereinbefore.

Many different sources and types of carbohydrates, lipids, proteins, minerals and vitamins are known and can be used in the nutritional compositions of the present invention, provided that such nutrients are compatible with the added ingredients in the selected formulation, are safe and effective for their intended use, and do not otherwise unduly impair product performance.

Carbohydrates for use in the compositions and methods of the present invention include hydrolyzed or intact, naturally and/or chemically modified, starches sourced from corn, tapioca, rice or potato, in waxy or non-waxy forms. Other non-limiting examples of suitable carbohydrate sources include hydrolyzed cornstarch, maltodextrin, glucose polymers, sucrose, corn syrup, corn syrup solids, glucose, fructose, high fructose corn syrup, and combinations thereof. The carbohydrates can comprise lactose or can be substantially free of lactose.

Proteins for use in the compositions and methods of the present invention include intact and hydrolyzed proteins, free amino acids, and combinations thereof. Non-limiting examples of suitable proteins include hydrolyzed, partially hydrolyzed or non-hydrolyzed protein, and can be derived from any known or otherwise suitable source such as milk (e.g., casein, whey, lactose-free milk protein isolates), animal (e.g., meat, fish), cereal (e.g., rice, corn), vegetable (e.g., soy), or combinations thereof. The protein can include, or be entirely or partially replaced by, free amino acids known or otherwise suitable for use in nutritional products, non-limiting examples of which include Non-limiting examples of free amino acids include L-alanine, L-arginine, L-asparagine, L-aspartic acid, L-camitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

Lipids suitable for use in the compositions and methods of the present invention include coconut oil, soy oil, corn oil, olive oil, safflower oil, high oleic safflower oil, MCT oil (medium chain triglycerides), sunflower oil, high oleic sunflower oil, structured triglycerides, palm and palm kernel oils, palm olein, canola oil, marine oils, cottonseed oils, and combinations thereof. Other suitable lipids or related materials include those that provide specific fatty acids, including arachidonic acid, docosahexaenoic acid, or mixtures thereof. These materials are known to provide beneficial effects in infants such as enhanced brain and vision development, descriptions of which are set forth in U.S. Pat. No. 5,492,938 (Kyle et al.), which descriptions are incorporated herein by reference. Non-limiting examples of suitable sources of arachidonic acid and docosahexaenoic acid include marine oil, egg derived oils, fungal oil, algal oil, and combinations thereof.

The nutritional compositions may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

The nutritional compositions may further comprise any of a variety of minerals known or otherwise suitable for us in infant or other nutritional formulas, non-limiting examples of which include calcium, phosphorus, magnesium, iron, zinc, manganese, copper, iodine, sodium, potassium, chloride, selenium, and combinations thereof.

The infant formula embodiments of the present invention preferably comprise nutrients in accordance with the relevant infant formula guidelines for the targeted consumer or user population, an example of which would be the Infant Formula Act, 21 U.S.C. Section 350(a). Preferred carbohydrate, lipid, and protein concentrations for use in the formulas are set forth in the following table.

TABLE 1
Infant Formula Nutrients

| Nutrient | Range | g/100 kcal | g/100 g powder | g/L as fed |
|---|---|---|---|---|
| Carbohydrate | Preferred | 8-16 | 30-90 | 54-108 |
| | More preferred | 9-13 | 45-60 | 61-88 |
| Lipid | Preferred | 3-8 | 15-35 | 20-54 |
| | More preferred | 4-6.6 | 25-25 | 27-45 |
| Protein | Preferred | 1-3.5 | 8-17 | 7-24 |
| | More preferred | 1.5-3.4 | 10-17 | 10-23 |

The infant formula embodiments of the present invention also preferably include per 100 kcal of formula one or more of the following: vitamin A (from about 250 to about 750 IU), vitamin D (from about 40 to about 100 IU), vitamin K (greater than about 4 μm), vitamin E (at least about 0.3 I”), vitamin C (at least about 8 mg), thiamine (at least about 8 μg), vitamin B12 (at least about 0.15 μg), niacin (at least about 250 μg), folic acid (at least about 4 μg), pantothenic acid (at least about 300 μg), biotin (at least about 1.5 μg), choline (at least about 7 mg), and inositol (at least about 2 mg).

The infant formula embodiments preferably include per 100 kcal of formula one or more of the following: calcium (at least about 50 mg), phosphorus (at least about 25 mg), magnesium (at least about 6 mg), iron (at least about 0.15 mg), iodine (at least about 5 μg), zinc (at least about 0.5 mg), copper (at least about 60 μg), manganese (at least about 5 μg), sodium (from about 20 to about 60 mg), potassium (from about 80 to about 200 mg), chloride (from about 55 to about 150 mg) and selenium (at least about 0.5 mcg).

The infant formula embodiments also preferably include, as part of the lipid component, arachidonic acid and docosahexaenoic acid, which have been shown to have beneficial effects in infants, including enhanced brain and vision development. These lipids and some of their effects are described, for example, in U.S. Pat. No. 5,492,938 (Kyle et al.), which description is incorporated herein by reference. Non-limiting examples of sources of these lipids include marine oil; egg derived oils, fungal oil, algal oil, and combinations thereof.

The infant formula embodiments preferably comprise one or more of arachidonic acid, docosahexaenoic acid, or combinations thereof, alone or in further combination with linoleic acid and linolenic acid. Arachidonic acid concentrations preferably range up to about 2.0%, more preferably from about 0.2% to about 1.0%, even more preferably from about 0.35% to about 0.9%, and most preferably from about 0.4% to about 0.5%, by weight of the total fatty acids in the formula. Docosahexaenoic acid concentrations preferably range up to about 1.0%, more preferably from about 0.1% to about 1.0%, and even more preferably from about 0.14% to about 0.36%, by weight of the total fatty acids in the formula. Linoleic concentrations preferably range up to about 30%, more preferably from about 10% to about 30%, and even more preferably from about 15% to about 20%, by weight of the total fatty acids in the formula. Linolenic acid concentrations preferably range up to about 4%, more preferably from about 1.5% to about 4%, even more preferably from about 2% to about 3%, and even more preferably from about 2.2% to about 2.6%. These preferred lipid materials are described in U.S. Pat. No. 6,495,599 (Auestad et al.), which description is incorporated herein by reference.

### III. OPTIONAL INGREDIENTS

The nutritional compositions of the present invention may further comprise other optional components that may modify the physical, chemical, aesthetic or processing characteristics of the formulas or serve as pharmaceutical or additional nutritional components when used in the targeted population. Many such optional ingredients are known for use in food and nutritional products, including infant formulas, and may also be used in the nutritional compositions of the present invention, provided that such optional materials are compatible with the essential materials described herein, are safe and effective for their intended use, and do not otherwise unduly impair product performance.

Non-limiting examples of such optional ingredients include preservatives, anti-oxidants, emulsifying agents, pharmaceuticals, buffers, colorants, flavors, nucleotides and nucleosides, thickening agents, stabilizers, and other excipients or processing aids.

### IV. METHOD OF MANUFACTURE

The nutritional compositions of the present invention may be prepared by any known or otherwise effective technique, suitable for making and formulating a the desired nutritional powder or liquid form, provided that the technique is modified so as to include a spray drying step as described hereinafter.

It has been found that added fiber as defined herein, especially soy fiber, can be formulated into a nutritional powder, or a nutritional liquid derived from the powder, provided that the fiber is first added to an aqueous slurry which may comprise one or more other formula ingredients other than water and fiber, e.g., nutrient base materials, homogenizing the aqueous slurry at a pressure of from about 500 psi to about 1300 psi, preferably from about 800 psi to about 1100 psi, more preferably from about 900 psi to about 1000 psi, at a temperature preferably at least about 120° F., more preferably from about 120° F. to about 180° F., even more preferably from about 150° F. to about 170° F. The homogenized liquid is then spray dried to form a fiber-containing nutritional powder.

It has also been found that the aqueous fiber-containing slurry, when subjected to the spray drying step, should contain less than about 7 g/liter, preferably from about 1 g/liter to about 6 g/liter, of the added fiber for improved product stability. It has been found that added fiber concentrations above about 7 g/liter in the aqueous slurry result in layering or separation of the slurry into a plurality of layers, which cannot then be readily subjected to the spray-drying step.

It has also been found that conventional dry mixing of added fiber into a nutritional powder does not typically result in a stable product when later reconstituted. The resulting dry mixed formula separates and readily clogs the nipple of the formula bottle. It is understood, however, that dry mixing steps can be applied to the compositions and methods of the present invention, provided that the added fiber component is first spray dried with a nutrient base or similar other material, and then dry mixed with other ingredients. Preferably, however, all of the formula ingredients, including the added fiber, are combined together and spray dried without any subsequent dry mixing steps.

The nutritional powders and other compositions of the present invention can be prepared by various methods known in the formulation arts, provided that the above-described process steps are included. For example, an appropriate quantity of formula protein can be dispersed or solubilized in water to form a protein solution or liquid. The non-fiber carbohydrate source for the formula (e.g., corn syrup solids, maltodextrins, sucrose) is dissolved or dispersed in water to form a carbohydrate solution or liquid. Appropriate minerals are dissolved or dispersed in water to form a mineral solution or liquid. And finally, purified dietary fiber, e.g., soy fiber, is dispersed or dissolved in a sufficient quantity of water to form a low viscosity liquid.

Once formed, the four solutions or liquids (protein, carbohydrate, mineral, and fiber) can be combined in appropriate quantities with the formula fats/oils and oil soluble vitamins. This resulting combination is then homogenized in a two-stage process at a selected pressure of 900/500 psi at a temperature of about 165° F., to thus achieve sufficient hydration of the fiber and create a matrix stable enough to spray-dry. Before spray drying, the homogenized liquid is standardized with appropriate water-soluble vitamins and heat treated to about 225° F. The heated liquid is then spray dried to an acceptable moisture content, most typically from about 1.5% to about 3.0% by weight of the powder, to form a fiber-containing nutritional powder embodiment of the present invention. The powder can be further processed or reconstituted to form a nutritional liquid.

### V. METHOD OF USE

The present invention is also directed to a method of providing nutrition and treating infants with colic, diarrhea, excessive spit-up, or combinations thereof, wherein the method comprises feeding the infants the fiber-containing nutritional formula of the present invention. The present invention is also directed to a method of providing infants with daily nutrition that includes daily dietary fiber intake from the nutritional formula of the present invention.

In the context of the methods of the present invention, the nutrition provided the infants may be used to meet their sole, primary, or supplemental nutritional needs. For powder embodiments, each method also includes the step of reconstituting the powder with an aqueous vehicle, most typically water or human milk, to form the desired caloric density, which is then orally or enterally fed to the infant to provide the desired nutrition. The powder is reconstituted with a quantity of water, or other suitable fluid such as human milk, to produce a volume suitable for about one feeding. Generally, from about 8 g to about 9 g of the nutritional powder are reconstituted with about 55 ml to about 65 ml of water to produce the desired nutrient density. The infant formula embodiments can be reconstituted to a variety of caloric densities, but will most typically range from about 19 to about 24 kcal/fl oz, more typically from about 20 to about 21 kcal/fl oz.

The use of fiber-containing nutritional compositions for treating infants with colic, diarrhea, or excessive spit-up are described in the infant nutrition literature. All such methods may be applied to and used in the context of the nutritional compositions of the present invention. Non-limiting examples of such descriptions are set forth in U.S. Pat. No. 6,017,550 (Berk et al.), and U.S. Pat. No. 5,021,245 (Borschel et al.), which descriptions are incorporated herein by reference.

### VI. EXAMPLES

The following examples illustrate specific embodiments of the nutritional compositions of the present invention, including methods of making the compositions, methods of using the compositions in providing daily nutrition and dietary fiber in infants, and methods of treating infants with diarrhea, colic, or excessive spit-up. The examples are given solely for the purpose of illustration and are not to be construed as limitations of the present invention, as many variations thereof are possible without departing from the spirit and scope of the invention.

Each of the following nutritional powder embodiments of the present invention is also reconstituted with water to form a corresponding nutritional liquid embodiment of the present invention. Each nutritional liquid embodiment contains between 0.1 g and 6 g of added, spray-dried fiber per liter, from 2 g to 7 g of total dietary fiber per liter, and has a caloric density of about 20 kcal/fl oz. Each of the liquid embodiments is used to provide infants with daily nutrition and a source of dietary fiber, and are also used to treat, prevent, or minimize, colic, diarrhea, excessive spit-up, or combinations thereof.

All exemplified ingredient amounts are listed on an as-is basis to formulate 100 kg of nutritional powder having a 2-3% final moisture content.

### EXAMPLE 1

The following example illustrates a soy-based nutritional powder embodiment of the present invention. The exemplified formula is described in Table 1.1

TABLE 1.1
Soy-based Nutritional Powder

| | Amount to formulate 100 kg |
|---|---|
| Ingredient | of nutritional powder |
| Soy Protein Isolate | 16 kg |
| Soy Oil | 17 kg |
| Coconut Oil | 11 kg |
| Corn Syrup (DE 25-35) | 36 kg |
| Sucrose granules | 19 kg |
| Soy Fiber² | 4.0 kg |
| L-methionine | 158 g |
| Mineral salts and vitamin premixes¹ | |

¹sufficient amount to meet IFA requirements for all minerals and vitamins
²Soy fiber as added fiber; approximately 80% insoluble and 20% soluble

The exemplified formula is prepared by first dispersing the carbohydrate (sucrose granules), soy fiber and minerals in water with appropriate heat and agitation to form a carbohydrate-mineral slurry. The soy protein isolate is then dispersed in vegetable oil (soy oil, coconut oil) along with any oil soluble vitamins, emulsifiers, and antioxidants, with appropriate heat and agitation to form a protein-oil slurry. The formed slurries are then blended together with corn syrup and the resulting pH adjusted to between 6.0 and 7.0 with an appropriate alkaline solution. Final total solid content of the resulting blend is 45-50.5%. The blend is then emulsified at 100-400 psi, subjected to high temperature steam treatment (HTST) at 160-170° F., and then homogenized using a 2-stage homogenization process at pressures of 900-1000 psi/400 psi. Water-soluble materials such as ascorbic acid, methionine, and trace minerals are then added to the homogenized mixture, which is then subjected to ultra high temperature (UHT) treatment at 220-250° F. The heat treated mixture is then cooled to 160-180° F. and spray dried at about 2300 psi at approximately 3 gal/min to yield a finished nutritional powder with a moisture content of 2-3% by weight of the powder, and a total dietary fiber content of about 6 g per 100 g of powder.

### EXAMPLE 2

The following example illustrates a lactose-free nutritional powder embodiment of the present invention. The exemplified formula is described in Table 2.2.

TABLE 2.2
Lactose-free Nutritional Powder

| | Amount to formulate 100 kg |
|---|---|
| Ingredient | of nutritional powder |
| Lactose-free milk protein | 14 kg |
| Soy Oil | 17 kg |
| Coconut Oil | 11 kg |
| Corn Syrup (DE 25-35) | 36 kg |
| Sucrose granules | 19 kg |
| Soy Fiber² | 4.0 kg |
| Mineral salts and vitamin premixes¹ | |

¹Sufficient amount to meet IFA requirements for all minerals and vitamins
²Soy fiber as added fiber; approximately 80% insoluble and 20% soluble

The exemplified formula is prepared by first dispersing the carbohydrate (sucrose granules), soy fiber and minerals in water with sufficient heat and agitation to form a carbohydrate-mineral slurry. The lactose free protein isolate is dispersed in vegetable oil (soy oil, coconut oil) along with any oil soluble vitamins, emulsifiers, and antioxidants, with sufficient heat and agitation to form a protein-oil slurry. The formed slurries are then blended together with corn syrup and the resulting pH adjusted to between 6.0 and 7.0 with an appropriate alkaline solution. Final total solid content of the resulting blend is 45-50.5%. The blend is then emulsified at a pressure of 100-400 psi, subjected to high temperature steam treatment (HTST) at 160-170° F., and then homogenized using a 2-stage homogenization process at pressures of 900-1000 psi/400 psi. Water-soluble materials or vitamins such as ascorbic acid, trace minerals, and other water-soluble vitamins are then added to the homogenized mixture, which is then subjected to ultra high temperature (UHT) treatment at 220-250° F. The heat treated mixture is then cooled to 160-180° F. and spray dried at about 2300 psi at 3 gal/min to yield a finished nutritional powder with a moisture content of 2-3% by weight of the powder and a total dietary fiber content of about 6 g per 100 g of powder.

### EXAMPLE 3

The following example illustrates a milk-based nutritional powder embodiment of the present invention. The exemplified formula is described in Table 3.3.

TABLE 3.3
Milk-based Nutritional Powder

| | Amount to formulate 100 kg |
|---|---|
| Ingredient | of nutritional powder |
| Condensed skim milk | 71.3 kg |
| Whey protein | 5.1 kg |
| Soy oil | 10.3 kg |
| Coconut oil | 6.9 kg |
| Lactose | 44.3 kg |
| Soy fiber² | 4.0 kg |
| Mineral salts and vitamin premixes¹ | |

¹Sufficient amount to meet IFA requirements for all minerals and vitamins
²Soy fiber as added fiber; approximately 80% insoluble and 20% soluble

The exemplified formula is prepared by first dispersing the carbohydrate (lactose), soy fiber and minerals in water with sufficient heat and agitation to form a carbohydrate-mineral slurry. Condensed skim milk and whey protein (for total protein ratios —53% casein, 47% whey) is then dispersed in vegetable oil (soy oil, coconut oil) along with any oil soluble vitamins, emulsifiers, and antioxidants, with sufficient heat and agitation to form a protein-oil slurry. The formed slurries are then blended together and the resulting pH adjusted to between 6.0 and 7.0 with an appropriate alkaline solution. The blend is then emulsified at a pressure of 100-500 psi, subjected to high temperature steam treatment (HTST) at 160-170° F., and then homogenized using a 2-stage homogenization process at pressures of 900-1000 psi/400 psi. The resulting mixture is evaporated to a total solids content of about 54-56%. Water soluble materials such as ascorbic acid, trace minerals, and other water soluble vitamins are then added to the homogenized mixture, which is then subjected to ultra high temperature (UHT) treatment at 220-250° F. The heat treated mixture is then cooled to 160-180° F. and spray dried at about 2300 psi at 3 gal/min to yield a finished nutritional powder with a moisture content of 2-3% by weight of the powder and a total dietary fiber content of about 6 g per 100 g of powder.

### EXPERIMENT

A study was conducted to evaluate the dietary management of infants using a nutritional powder containing added fiber. One purpose of the study was to compare and evaluate the effective dose of fiber from a nutritional powder relative to a ready-to-feed liquid formula. For purposes of the experiment, an effective dose was defined as the amount of added soy fiber per liter of formula to achieve an average mean rank stool consistency (MRSC) in infants of between 3.5 and 4.0. The MRSC scores are based on a 1-5 scale (1-watery, 2-loose, 3-soft, 4-formed, 5-hard).

The study products included a nutritional powder embodiment of the present invention, which was a soy-based, infant formula containing added soy fiber. The nutritional powder was similar to, and evaluated relative to, a commercially available ready-to-feed, soy-based, infant formula containing added soy fiber (Isomil® DF RTF Infant formula, commercially available from Ross Products Division-Abbott Laboratories, Columbus, Ohio, U.S.A). The commercial ready-to-feed (RTF) formula contained 6 g of added soy fiber per each liter of formula.

The experiment included a dose-response study of healthy term infants fed the powder-based infant formula having 3.3 g of added soy fiber per liter of reconstituted formula. On day one of the study, infants remained on their previous infant formula for three days while parents recorded daily stool characteristics and formula intake. On day 5, each of the infants were switched from their previous formula to the powder infant formula as their sole source of nutrition for the next 10 days. Parents recorded daily stool characteristics and formula intake.

Results

MRSC scores were then calculated for the group of infants in the study, all of which received the powder formula containing 3.3 g of added soy fiber per liter of reconstituted formula. Scores ranged from 3.5-4.0 (6 infants), greater than 4.0 (3 infants) and less than 3.5 (1 infant). These scores were then compared to a previous study in which infants were fed the ready-to-feed liquid formula referenced above at 6 g of added soy fiber per liter of formula scored an average MRSC of from 3.5-4.0.

The results of the study were surprising. It was found that the powder formula, which contained less added soy fiber (3.3 g/L) than the commercial ready-to-feed formula (6 g/L), resulted in stool firming scores for 60% of the infants that were similar to the stool firming scores registered for infants fed a similar ready-to-feed formula, and even firmer stools for 30% of the infants. This study suggests that the spray dried soy fiber of the powder infant formula can be used at lower concentrations and dosages (e.g., 3.3 g/L) to achieve the same or similar results achieved by higher added soy concentrations and dosages (6 g/L) in a ready-to-feed infant formula.

What is claimed is:

1. A method of preparing a nutritional powder, said method comprising;
(A) preparing an aqueous liquid containing
(i) protein, fat, carbohydrate, or combinations thereof, and
(ii) from about 0.1 g to about 7 g of added fiber per liter of the aqueous liquid, wherein at least about 50% by weight of the added fiber is water insoluble;
(B) homogenizing the prepared aqueous liquid at a homogenization pressure of from about 500 psi to about 1300 psi; and
(C) spray drying the homogenized liquid to form a nutritional powder.

2. The method of claim 1, wherein the added fiber comprises soy fiber.

3. The method of claim 2, wherein the aqueous liquid comprises from about 1 g to about 6 g of added fiber per liter.

4. The method of claim 2, wherein the nutritional powder comprises from about 1 g to about 7 g of total dietary fiber per 100 g of the nutritional powder.

5. The method of claim 2, wherein the nutritional powder comprises from about 2 g to about 6 g of total dietary fiber per 100 g of the nutritional powder.

6. The method of claim 2 wherein the homogenization pressure is from about 800 psi to about 1 100 psi.

7. The method of claim 2 wherein the homogenization pressure is from about 900 psi to about 1000 psi.

8. The method of claim 2, wherein from about 50% to about 90% by weight of the added fiber is water insoluble, and from about 10% to about 50% by weight of the added fiber is water soluble.

9. The method of claim 2, wherein the nutritional powder comprises from about 30% to about 90% carbohydrate, from about 15% to about 35% lipid, and from about 8% to about 17% protein, by weight of the nutritional powder.

10. The method of claim 2, wherein the total dietary fiber includes up to about 2 g of inherent fiber per 100 g of the nutritional powder.

11. The method of claim 2, wherein the spray-dried nutritional powder is not subjected to a dry-mixing step after the spray-drying step.

12. A nutritional liquid comprising:
(A) protein, fat, carbohydrate, or combinations thereof, and
(B) a total dietary fiber component, wherein the total dietary fiber comprises added spray-dried fiber of which at least about 50% by weight is water insoluble.

13. The nutritional liquid of claim 12, wherein the added, spray-dried fiber comprises soy fiber.

14. The nutritional liquid of claim 13, wherein the nutritional liquid comprises from about 0.1 g to about 7 g of the added, spray-dried, fiber per liter.

15. The nutritional liquid of claim 13, wherein the nutritional liquid comprises from about 1 g to about 6 g of the added, spray-dried, fiber per liter.

16. The nutritional liquid of claim 13, wherein the nutritional liquid comprises from about 1 g to about 9 g of total dietary fiber per liter.

17. The nutritional liquid of claim 16, wherein the total dietary fiber includes up to about 3 g of inherent fiber per liter.

18. The nutritional liquid of claim 13, wherein from about 50% to about 90% by weight of the added, spray-dried fiber is water insoluble and from about 10% to about 50% by weight of the added, spray-dried, fiber is water soluble.

19. The nutritional liquid of claim 13, wherein the nutritional liquid comprises, per liter, from about 54 g to about 108 g of carbohydrate, from about 20 g to about 54 g of lipid, and from about 7 g to about 24 g of protein.

20. A nutritional powder comprising:
(A) protein, fat, carbohydrate, or combinations thereof, and
(A) a total dietary fiber component, wherein the total dietary fiber contains added spray-dried fiber of which at least about 50% by weight of the added spray-dried fiber is water insoluble.

21. The nutritional powder of claim 20, wherein the added spray-dried fiber comprises soy fiber.

22. The nutritional powder of claim 20, wherein the nutritional powder comprises from about 1 g to about 7 g of total dietary fiber per 100 g of the nutritional powder.

23. The nutritional powder of claim 20, wherein the nutritional powder comprises from about 2 g to about 6 g of total dietary fiber per 100 g of the nutritional powder.

24. The nutritional powder of claim 20, wherein the nutritional powder comprises from about 0.1 g to about 5 g of added, spray-dried, fiber per 100 g of the nutritional powder.

25. The nutritional powder of claim 20, wherein the nutritional powder comprises from about 1 g to about 4.5 g of added, spray-dried, fiber per 100 g of the nutritional powder.

26. The nutritional powder of claim 20, wherein from about 50% to about 90% by weight of the added fiber is water insoluble, and from about 10% to about 50% by weight of the added fiber is water soluble.

27. The nutritional powder of claim 20, wherein the nutritional powder comprises from about 30% to about 90% carbohydrate, from about 15% to about 35% lipid, and from about 8% to about 17% protein, by weight of the nutritional powder.

28. The nutritional powder of claim 20, wherein the total dietary fiber includes up to about 2 g of inherent fiber per 100 g of the nutritional powder.

29. A method of treating or reducing the incidence of colic, diarrhea, spit-up, or combinations thereof, in infants, said method comprising feeding the infants the nutritional liquid of claim 12.

30. A method of providing nutrition and dietary fiber to infants, said method comprising feeding the infants the nutritional liquid of claim 12.
